(19) United States
(12) Patent Application Publication
(10) Pub. No.: US 2009/0201427 A1
(43) Pub. Date: Aug. 13, 2009

(54) METHOD AND SYSTEM FOR PIXEL ADAPTIVE WEIGHTED MEDIAN FILTERING FOR BLOCK MOTION VECTOR DECOMPOSITION

(76) Inventor: Brian Heng, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 12/029,573

(22) Filed: Feb. 12, 2008

(51) Int. Cl. H04N 5/14

(52) U.S. Cl. 348/699; 348/E05.062

(57) ABSTRACT

Aspects of a method and system for pixel adaptive weighted median filtering for block motion vector decomposition are presented. Aspects of the system may include an image interpolation system that enables decomposition of a plurality of pixel block level motion vectors into a plurality of pixel level motion vectors. The image interpolation system may enable generation of a plurality of pixel values within an interpolated image frame based on the plurality of pixel level motion vectors.

### CROSS-REFERENCE TO RELATED APPLICATIONS/INCORPORATION BY REFERENCE

This application makes reference to U.S. application Ser. No. 12/013,882 filed on Jan. 14, 2008, which is hereby incorporated herein by reference in its entirety.

### FIELD OF THE INVENTION

Certain embodiments of the invention relate to digital video. More specifically, certain embodiments of the invention relate to a method and system for pixel adaptive weighted median filtering for block motion vector decomposition.

### BACKGROUND OF THE INVENTION

In many video processing applications, in which moving objects may be displayed in a sequence of image frames, it may be useful to have knowledge of the motion which occurs from frame to frame. Examples of such applications include, frame rate conversion, deinterlacing, noise reduction, and cross-chroma reduction. In a typical method for frame rate conversion, for example one that enables doubling of the frame rate of a video sequence, each image frame may be repeated twice. By taking this information into account, one can perform adaptive processing that adapts to and compensates for the motion in the scene.

There have been many methods proposed for modeling the motion in a scene. One such method is a translational block-based model. In this model, the original frame is broken into small blocks, and the motion between frames is modeled in terms of translational shifts of these blocks. Each block is assigned a two-dimensional (horizontal/vertical) motion vector (MV) that describes the translational shift assigned to each block.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for pixel adaptive weighted median filtering for block motion vector decomposition substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram that illustrates an exemplary method for computing a plurality of pixel block level motion vectors, in accordance with an embodiment of the invention.

FIG. 1B is a block diagram that illustrates an exemplary method for computing a plurality of pixel level motion vectors, in accordance with an embodiment of the invention.

FIG. 2A is a block diagram of an exemplary system for generating interpolated image frames, in accordance with an embodiment of the invention.

FIG. 2B is a block diagram of an exemplary system for generating pixel level motion vectors, in accordance with an embodiment of the invention.

FIG. 3 is a flowchart illustrating exemplary steps for pixel adaptive weighted median filtering for motion vector decomposition, in accordance with an embodiment of the invention.

### DETAILED DESCRIPTION OF THE INVENTION

Certain embodiments of the invention relate to a method and system for pixel adaptive weighted median filtering for block motion vector decomposition. Various embodiments of the invention comprise a method and system in which a plurality of picture element (pixel) block level motion vectors may be computed based on a pixel block location within a preceding image frame and a corresponding plurality of pixel block locations within a current image frame. Based on the plurality of pixel block motion vectors, a plurality of pixel level motion vectors may be computed that correspond to a corresponding plurality of pixels contained within one of the plurality of pixel block locations within the current image frame. For each of the pixel level motion vectors, a distance value may be computed. For each of the pixel level motion vectors a corresponding weighting coefficient may be selected. A median filtering metric may be computed based on a selected group of distance values and corresponding weighing coefficients. Based on the median filtering metric, a weighted block level motion vector may be generated. The method for computing a plurality of median filtering metrics for a given image frame may be referred to as weighted median filtering. Median filtering may enable generation of a pixel level motion vector based on the plurality of weighted block level motion vectors. The pixel level motion vector may be utilized to determine a pixel location within an interpolated image frame. The pixel value for the determined pixel location may be determined based on the value of the pixel within the current image frame that corresponds to the pixel level motion vector. A method for generating pixel level motion vectors based on pixel block level motion vectors may referred to as pixel motion vector decomposition.

In various embodiments of the invention, a confidence level value may be determined for each of the plurality of pixel block level motion vectors. The confidence level may be associated with each of the plurality of pixel block level motion vectors. The confidence level for each of the motion vectors may be compared to a threshold confidence level. Pixel block level motion vectors for which the confidence level exceeds the threshold level may be utilized to enable computation of the pixel level motion vectors.

In various embodiments of the invention, motion vectors may be computed utilizing various methods and/or techniques. While one or more exemplary methods for motion vector computation may be described, implied and/or suggested below, for the purposes of this application, various embodiments of the invention are not limited to any specific method for motion vector computation.

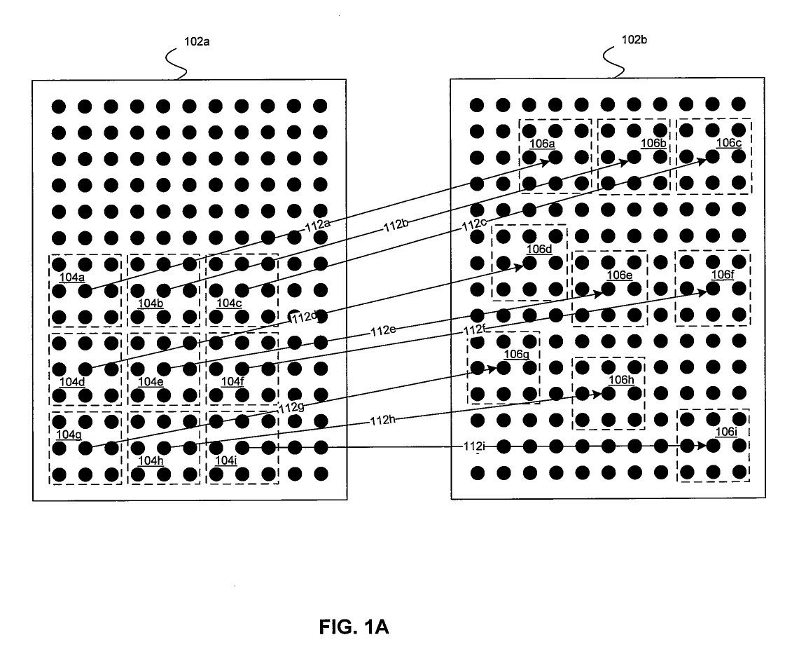

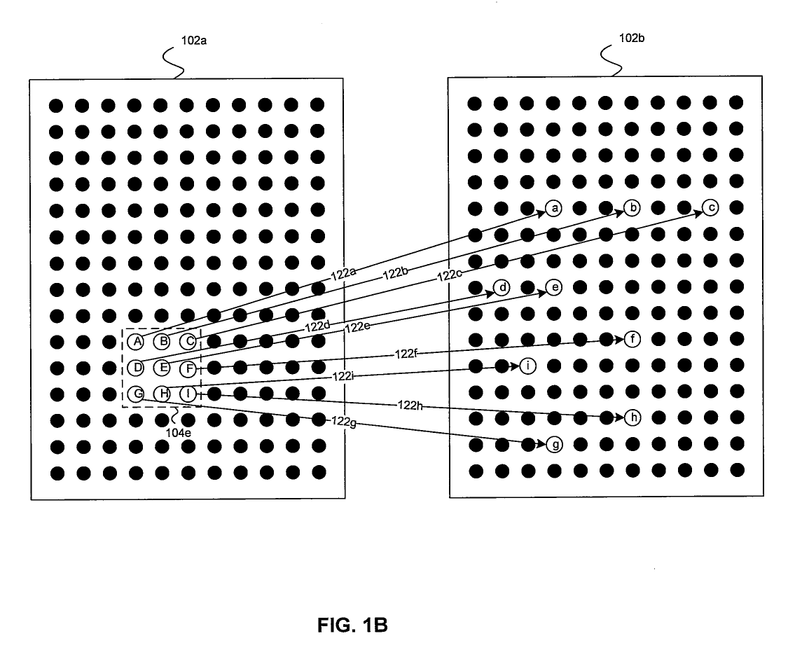

FIG. 1A is a block diagram that illustrates an exemplary method for computing a plurality of pixel block level motion vectors, in accordance with an embodiment of the invention. Referring to FIG. 1A, there is shown a plurality of pixel block level motion vectors 112a, 112b, 112c, 112d, 112e, 112f, 112g, 112h and 112i.

In an exemplary embodiment of the invention, the motion vector 112a may be computed based on a preceding image processing block 104a within a preceding image frame 102a and a corresponding current image processing block 106a within a current image frame 102b. The motion vector 112b may be computed based on the preceding image processing block 104b and a corresponding current image processing block 106b within the current image frame 102b. The motion vector 112c may be computed based on the preceding image processing block 104c and a corresponding current image processing block 106c within the current image frame 102b. The motion vector 112d may be computed based on the preceding image processing block 104d and a corresponding current image processing block 106d within the current image frame 102d. The motion vector 112e may be computed based on the preceding image processing block 104e and a corresponding current image processing block 106e within the current image frame 102b. The motion vector 112f may be computed based on the preceding image processing block 104f and a corresponding current image processing block 106f within the current image frame 102b. The motion vector 112g may be computed based on the preceding image processing block 104g and a corresponding current image processing block 106g within the current image frame 102b. The motion vector 112h may be computed based on the preceding image processing block 104h and a corresponding current image processing block 106h within the current image frame 102b. The motion vector 112i may be computed based on the preceding image processing block 104i and a corresponding current image processing block 106i within the current image frame 102b.

In various embodiments of the invention, each of the image processing blocks 104a, 104b, 104c, 104d, 104e, 104f, 104g, 104h, 104i, 106a, 106b, 106c, 106d, 106e, 106f, 106g, 106h and 106i may comprise a pixel neighborhood. As shown in the exemplary FIG. 1A, each of the image processing blocks 104a, 104b, 104c, 104d, 104e, 104f, 104g, 104h, 104i, 106a, 106b, 106c, 106d, 106e, 106f, 106g, 106h and 106i comprise a 3×3 pixel neighborhood. The pixel block level motion vectors 112a, 112b, 112c, 112d, 112e, 112f, 112g, 112h and 112i may be computed utilizing various image processing methods.

FIG. 1B is a block diagram that illustrates an exemplary method for computing a plurality of pixel level motion vectors, in accordance with an embodiment of the invention. Referring to FIG. 1B, there is shown a plurality of pixel level motion vectors 122a, 122b, 122c, 122d, 122e, 122f, 122g, 122h and 122i. The pixel level motion vectors 122a, 122b, 122c, 122d, 122e, 122f, 122g, 122h and 122i may be computed based on the pixel block level motion vectors 112a, 112b, 112c, 112d, 112e, 112f, 112g, 112h and 112i.

The motion vector 122a may correspond to a motion vector, which references the pixel location label_A within preceding image processing block 104a and the pixel location label_a within current image processing block 106e. The motion vector 122b may correspond to a motion vector, which references the pixel location label_B within preceding image processing block 104a and the pixel location label_b within current image processing block 106e. The motion vector 122c may correspond to a motion vector, which references the pixel location label_C within a preceding image processing block 104b, within the preceding image frame 102a, and the pixel location label_c within current image processing block 106e.

The motion vector 122d may correspond to a motion vector, which references the pixel location label_D within preceding image processing block 104a and the pixel location label_d within current image processing block 106e. The motion vector 122e may correspond to a motion vector, which references the pixel location label_E within preceding image processing block 104a and the pixel location label_e within current image processing block 106e. The motion vector 122f may correspond to a motion vector, which references the pixel location label_F within preceding image processing block 104b and the pixel location label_f within current image processing block 106e.

The motion vector 122g may correspond to a motion vector, which references the pixel location label_G within preceding image processing block 104a and the pixel location label_g within current image processing block 106e. The motion vector 122h may correspond to a motion vector, which references the pixel location label_H within preceding image processing block 104a and the pixel location label_h within current image processing block 106e. The motion vector 122i may correspond to a motion vector, which references the pixel location label_I within preceding image processing block 104b and the pixel location label_i within current image processing block 106e.

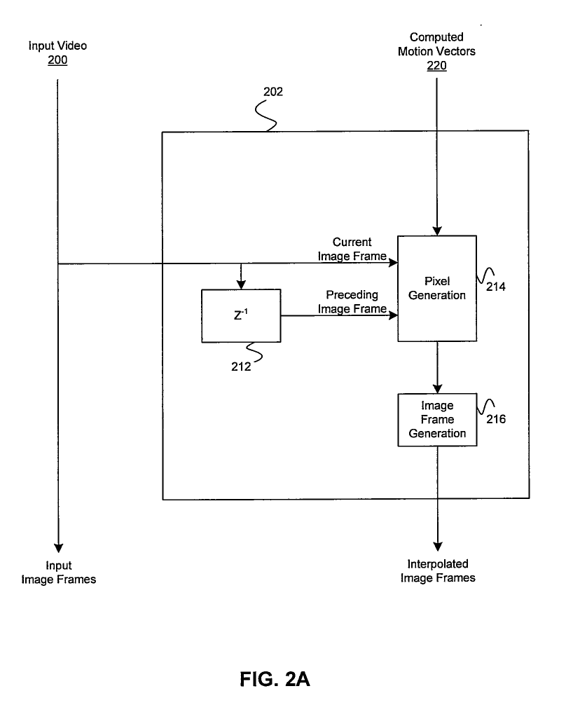

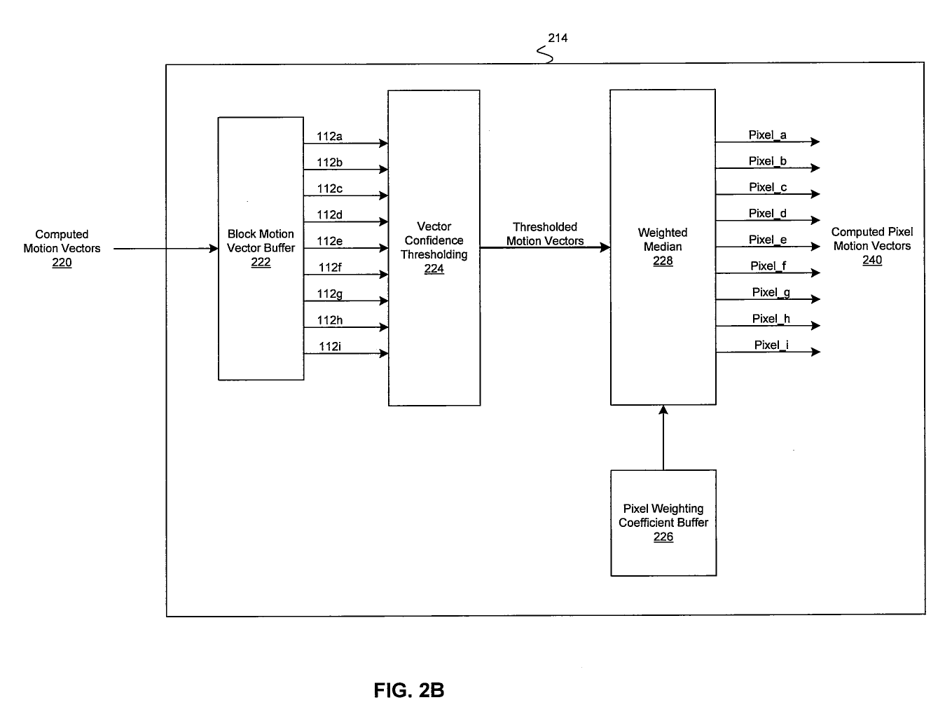

FIG. 2A is a block diagram of an exemplary system for generating interpolated image frames, in accordance with an embodiment of the invention. Referring to FIG. 2A, there is shown an image interpolation system 202. The image interpolation system 202 may comprise suitable logic, circuitry and/or code that may enable reception of input video 200 and computed motion vectors 220. The input video 200 may comprise a sequence of image frames.

The image interpolation system 202 may comprise a delay block 212, a pixel generation block 214 and an image frame generation block 216. The delay block 212 may receive input video 200 and output a time delayed version of the input video. In an exemplary embodiment of the invention, the delay block 212 may insert a one image frame time delay between the received input video 200 and the output. The delay block 212 may receive one or more current image frames and output a one image frame time delayed version of the input current image frames. The time delayed version of the input current image frames may be referred to as preceding image frames.

The pixel generation block 214 may comprise suitable logic, circuitry and/or code that may enable reception of one or more current image frames, one or more preceding image frames and computed motion vectors 220. Based on these inputs, the pixel generation block 214 may enable generation of interpolated image processing blocks. In various embodiments of the invention, the pixel generation block 214 may receive a plurality of pixel block level motion vectors and compute a plurality of pixel level motion vectors. Pixel values within the interpolated image processing blocks may be determined based on the pixel level motion vectors.

The pixel generation block 214 may comprise suitable logic, circuitry and/or code that may enable selection of a preceding image processing block within the preceding image frame and a current image processing block within the current image frame based on the selected motion vector. The pixel generation block 214 may generate pixel values within the interpolated image processing block based on the corresponding pixel values within the selected preceding and/or current image frames.

The image frame generation block 216 may comprise suitable logic, circuitry and/or code that may enable generation of interpolated image frames based on received interpolated image processing blocks. In an exemplary embodiment of the invention, the image frame generation block 216 may receive interpolated image processing blocks generated by the pixel generation block 214. The image frame generation block 216 may determine whether a sequence of received interpolated image processing blocks are contained within the same interpolated image frame. The image frame generation block 216 may determine the location of each received interpolated image processing block within an interpolated image frame. Upon assembling the group of interpolated image processing blocks associated with a given interpolated image frame the image frame generation block 216 may output a completed interpolated image frame.

FIG. 2B is a block diagram of an exemplary system for generating pixel level motion vectors, in accordance with an embodiment of the invention. Referring to FIG. 2B, there is shown the pixel generation block 214. The pixel generation block 214 may comprise a block motion vector buffer 222, a vector confidence thresholding block 224, a pixel weighting coefficient buffer 226 and a weighted median block 228.

The block motion vector buffer 222 may comprise suitable logic, circuitry and/or code that may enable storage of received computed motion vectors 220. The motion vectors 220 may comprise a plurality of pixel block level motion vectors. The block motion vector buffer may receive a plurality of pixel block level motion vectors 112a, 112b, 112c, 112d, 112e, 112f, 112g, 112h and 112i in a serial or parallel manner. The block motion vector buffer 222 may buffer the received motion vectors and output the plurality of pixel block level motion vectors 112a, 112b, 112c, 112d, 112e, 112f, 112g, 112h and 112i in a serial or parallel manner.

The vector confidence thresholding block 224 may evaluate a confidence attribute associated with each of the pixel block level motion vectors, when present. The vector confidence thresholding block 224 may compare the value of each of the confidence attribute(s) to a threshold value to select one or more of the pixel block level motion vectors 112a, 112b, 112c, 112d, 112e, 112f, 112g, 112h and 112i based on the comparison. The selected pixel block level motion vectors may comprise a plurality of thresholded motion vectors.

The pixel weighting coefficient buffer 226 may comprise suitable logic, circuitry and/or code that may enable storage of a plurality of weighting factors. The plurality of weighting factors may be logically divided into distinct groups, wherein each group is associated with a pixel location within an image processing block, which comprises P×Q pixel locations. Each of the weighting factors may be represented by the notion w_{j,k}, where j refers to a pixel location within an image processing block (for example label_a-label_i) and k may refer to a pixel block level motion vector (for example 112a-112i).

The weighted median block 228 may comprise suitable logic, circuitry and/or code that may enable reception of thresholded motion vectors and weighting factors, which may be utilized to enable the generation of a plurality of computed pixel motion vectors 240. The computed pixel motion vectors 240 may comprise a plurality of pixel level motion vectors 122a, 122b, 122c, 122d, 122e, 122f, 122g, 122h and 122i. In various exemplary embodiments of the invention, the weighted median block 228 may utilize a scalar median computation method. In various other exemplary embodiments of the invention, the weighted median block may utilize a vector median computation method.

In an exemplary embodiment of the invention the weighted median block 228 may utilize the scalar median computation method. Each of the image processing blocks within the preceding image frame may be represented by an x-y coordinate location tuple (pb_xₘ,pb_yₘ), where m represents an identifier for an image processing block within the preceding image frame. Each of the image processing blocks within the blocks within the current image frame may be represented by an x-y coordinate location tuple (cb_xₙ,cb_yₙ), where n represents an identifier for an image processing block within the preceding image frame.

The pixel block level motion vector 112a may be represented based on the x-y coordinate difference between the location of the preceding image processing block 104a within the preceding image frame 102a, (pb_x₁₀₄ₐ,pb_y₁₀₄ₐ), and the location of the current image processing block 106a within the current image frame 102b, (cb_x₁₀₆ₐ,cb_y₁₀₆ₐ). The x-y coordinate difference for the pixel block level motion vector 112a may be represented by the difference tuple (cb_x₁₀₆ₐ−pb_x₁₀₄ₐ,cb_y₁₀₆ₐ−pb_y₁₀₄ₐ).

Similarly, the x-y coordinate difference for the pixel block level motion vector 112b may be represented by the difference tuple (cb_x_{106b}−pb_x₁₀₄ₐ,cb_y_{106b}−pb_y₁₀₄ₐ), the x-y coordinate difference for the pixel block level motion vector 112c may be represented by the difference tuple (cb_x_{106c}−pb_x₁₀₄ₐ,cb_y_{106c}−pb_y₁₀₄ₐ), the x-y coordinate difference for the pixel block level motion vector 112d may be represented by the difference tuple (cb_x_{106d}−pb_x₁₀₄ₐ,cb_y_{106d}−pb_y₁₀₄ₐ), the x-y coordinate difference for the pixel block level motion vector 112e may be represented by the difference tuple (cb_x₁₀₆ₑ−pb_x₁₀₄ₐ,cb_y₁₀₆ₑ−pb_y₁₀₄ₐ), the x-y coordinate difference for the pixel block level motion vector 112f may be represented by the difference tuple (cb_x_{106f}−pb_x₁₀₄ₐ,cb_y_{106f}−pb_y₁₀₄ₐ), the x-y coordinate difference for the pixel block level motion vector 112g may be represented by the difference tuple (cb_x_{106g}−pb_x₁₀₄ₐ,cb_y_{106g}−pb_y₁₀₄ₐ), the x-y coordinate difference for the pixel block level motion vector 112h may be represented by the difference tuple (cb_x₁₀₆ₕ−pb_x₁₀₄ₐ,cb_y₁₀₆ₕ−pb_y₁₀₄ₐ) and the x-y coordinate difference for the pixel block level motion vector 112i may be represented by the difference tuple (cb_x₁₀₆ᵢ−pb_x₁₀₄ₐ,cb_y₁₀₆ᵢ−pb_y₁₀₄ₐ).

Based on the coordinate difference representations for each of the pixel block level motion vectors, 112a, 112b, 112c, 112d, 112e, 112f, 112g, 112h and 112i, a plurality of pixel level motion vectors, 122a, 122b, 122c, 122d, 122e, 122f, 122g, 122h and 122i, may be computed. The computation of the pixel level motion vectors may also depend upon the values for the weighting factors associated with each of the pixels within a given image processing block.

In an exemplary embodiment of the invention, the weighting factors for pixel label_a within current image processing block 106e may be represented as shown in the following equations:

w_{a,112a}=3

w_{a,112b}=4

w_{a,112c}=1

w_{a,112d}=4

w_{a,112e}=5

w_{a,112f}=1

w_{a,112g}=1

w_{a,112h}=1

w_{a,112i}=1 [1a]

The weighting factors for pixel label_b within current image processing block 106e may be represented as shown in the following equations:

w_{b,112a}=2

w_{b,112b}=5

w_{b,112c}=2

w_{b,112d}=3

w_{b,112e}=6

w_{b,112f}=3

w_{b,112g}=1

w_{b,112h}=1

w_{b,112i}=1 [1b]

The weighting factors for pixel label_c within current image processing block 106e may be represented as shown in the following equations:

w_{c,112a}=1

w_{c,112b}=4

w_{c,112c}=3

w_{c,112d}=1

w_{c,112e}=5

w_{c,112f}=4

w_{c,112g}=1

w_{c,112h}=1

w_{c,112i}=1 [1c]

The weighting factors for pixel label_d within current image processing block 106e may be represented as shown in the following equations:

w_{d,112a}=2

w_{d,112b}=3

w_{d,112c}=1

w_{d,112d}=5

w_{d,112e}=6

w_{d,112f}=1

w_{d,112g}=2

w_{d,112h}=3

w_{d,112i}=1 [1d]

The weighting factors for pixel label_e within current image processing block 106e may be represented as shown in the following equations:

w_{e,112a}=1

w_{e,112b}=4

w_{e,112c}=1

w_{e,112d}=4

w_{e,112e}=7

w_{e,112f}=4

w_{e,112g}=1

w_{e,112h}=4

w_{e,112i}=1 [1e]

The weighting factors for pixel label_f within current image processing block 106e may be represented as shown in the following equations:

w_{f,112a}=1

w_{f,112b}=3

w_{f,112c}=2

w_{f,112d}=1

w_{f,112e}=6

w_{f,112f}=5

w_{f,112g}=1

w_{f,112h}=3

w_{f,112i}=2 [1f]

The weighting factors for pixel label_g within current image processing block 106e may be represented as shown in the following equations:

w_{g,112a}=1

w_{g,112b}=1

w_{g,112c}=1

w_{g,112d}=4

w_{g,112e}=5

w_{g,112f}=1

w_{g,112g}=3

w_{g,112h}=4

w_{g,112i}=1 [1g]

The weighting factors for pixel label_h within current image processing block 106e may be represented as shown in the following equations:

w_{h,112a}=1

w_{h,112b}=1

w_{h,112c}=1

w_{h,112d}=3

w_{h,112e}=6

w_{h,112f}=3

w_{h,112g}=2

w_{h,112h}=5

w_{h,112i}=2 [1h]

The weighting factors for pixel label_i within current image processing block 106e may be represented as shown in the following equations:

w_{i,112a}=1

w_{i,112b}=1

w_{i,112c}=1

w_{i,112d}=1

w_{i,112e}=5

w_{i,112f}=4

w_{i,112g}=1

w_{i,112h}=4

w_{i,112i}=3 [1i]

In an exemplary embodiment of the invention, at the pixel location label_a, a the weighting factors, as shown in equation [1a] may be utilized to generate a plurality of tuple sets, (Δv_xₖ, Δv_yₖ), based on the plurality of block level motion vectors 112a, 112b, 112c, 112d, 112e, 112f, 112g, 112h and 112i as shown in the following equations:

Δv_{—}x₁₁₂ₐ={cb_{—}x₁₀₆ₐ−pb_{—}x₁₀₆ₐ)₁,K,(cb_{—}x₁₀₆ₐ−pb_{—}x₁₀₆ₐ)_{w}_{_{a,112a}}}

Δv_{—}y₁₁₂ₐ={cb_{—}y₁₀₆ₐ−pb_{—}y₁₀₆ₐ)₁,K,(cb_{—}y₁₀₆ₐ−pb_{—}y₁₀₆ₐ)_{w}_{_{a,112a}}} [2a]

where for tuple set Δv_x₁₁₂ₐ the coordinate difference (cb_x₁₀₆a−pb_x₁₀₆ₐ) is represented w_{a,112a} times. When w_{a,112a}=0, the tuple set Δv_x₁₁₂ₐ may be represented as a empty set. The tuple set Δv_y₁₁₂ₐ may be generated by a method that is substantially similar to that used for generating the tuple set Δv_x₁₁₂ₐ. The remaining tuple sets may be similarly generated:

Δv_{—}x_{112b}={cb_{—}x_{106b}−pb_{—}x_{106b})₁,K,(cb_{—}x_{106b}−pb_{—}x_{106b})_{w}_{_{a,112b}}}

Δv_{—}y_{112b}={cb_{—}y_{106b}−pb_{—}y_{106b})₁,K,(cb_{—}y_{106b}−pb_{—}y_{106b})_{w}_{_{a,112b}}} [2b]

Δv_{—}x_{112c}={cb_{—}x_{106c}−pb_{—}x_{106c})₁,K,(cb_{—}x_{106c}−pb_{—}x_{106c})_{w}_{_{a,112c}}}

Δv_{—}y_{112c}={cb_{—}y_{106c}−pb_{—}y_{106c})₁,K,(cb_{—}y_{106c}−pb_{—}y_{106c})_{w}_{_{a,112c}}} [2c]

Δv_{—}x_{112d}={cb_{—}x_{106d}−pb_{—}x_{106d})₁,K,(cb_{—}x_{106d}−pb_{—}x_{106d})_{w}_{_{a,112d}}}

Δv_{—}y_{112d}={cb_{—}y_{106d}−pb_{—}y_{106d})₁,K,(cb_{—}y_{106d}−pb_{—}y_{106d})_{w}_{_{a,112d}}} [2d]

Δv_{—}x₁₁₂ₑ={cb_{—}x₁₀₆ₑ−pb_{—}x₁₀₆ₑ)₁,K,(cb_{—}x₁₀₆ₑ−pb_{—}x₁₀₆ₑ)_{w}_{_{a,112e}}}

Δv_{—}y₁₁₂ₑ={cb_{—}y₁₀₆ₑ−pb_{—}y₁₀₆ₑ)₁,K,(cb_{—}y₁₀₆ₑ−pb_{—}y₁₀₆ₑ)_{w}_{_{a,112e}}} [2e]

Δv_{—}x_{112f}={cb_{—}x_{106f}−pb_{—}x_{106f})₁,K,(cb_{—}x_{106f}−pb_{—}x_{106f})_{w}_{_{a,112f}}}

Δv_{—}y_{112f}={cb_{—}y_{106f}−pb_{—}y_{106f})₁,K,(cb_{—}y_{106f}−pb_{—}y_{106f})_{w}_{_{a,112f}}} [2f]

Δv_{—}x_{112g}={cb_{—}x_{106g}−pb_{—}x_{106g})₁,K,(cb_{—}x_{106g}−pb_{—}x_{106g})_{w}_{_{a,112g}}}

Δv_{—}y_{112g}={cb_{—}y_{106g}−pb_{—}y_{106g})₁,K,(cb_{—}y_{106g}−pb_{—}y_{106g})_{w}_{_{a,112g}}} [2g]

Δv_{—}x₁₁₂ₕ={cb_{—}x₁₀₆ₕ−pb_{—}x₁₀₆ₕ)₁,K,(cb_{—}x₁₀₆ₕ−pb_{—}x₁₀₆ₕ)_{w}_{_{a,112h}}}

Δv_{—}y₁₁₂ₕ={cb_{—}y₁₀₆ₕ−pb_{—}y₁₀₆ₕ)₁,K,(cb_{—}y₁₀₆ₕ−pb_{—}y₁₀₆ₕ)_{w}_{_{a,112h}}} [2h]

Δv_{—}x₁₁₂ᵢ={cb_{—}x₁₀₆ᵢ−pb_{—}x₁₀₆ᵢ)₁,K,(cb_{—}x₁₀₆ᵢ−pb_{—}x₁₀₆ᵢ)_{w}_{_{a,112i}}}

Δv_{—}y₁₁₂ᵢ={cb_{—}y₁₀₆ᵢ−pb_{—}y₁₀₆ᵢ)₁,K,(cb_{—}y₁₀₆ᵢ−pb_{—}y₁₀₆ᵢ)_{w}_{_{a,112i}}} [2i]

Based on the plurality of values Δv_xₖ computed in equations [2], a composite tuple, cv_xₐ, may be generated:

cv_{—}xₐ={Δv_{—}x₁₁₂ₐ,K,Δv_{—}x₁₁₂ᵢ} [3]

and a median value mv_xₖ may be computed. In an exemplary embodiment of the invention, the values in the composite tuple cv_xₐ may be sorted, for example in ascending order and a middle value in the sorted range may be selected as the median value. By a similar method, a composite tuple, cv_yₐ, may be generated and a median value mv_yₖ computed. The pixel level motion vector 122a may be represented by the tuple (mv_xₖ,mv_yₖ). Based on the tuple (mv_xₖ,mv_yₖ) and the location of the pixel label_a, within the current image frame 102b, the location of a corresponding pixel within an interpolated image frame may be determined. The interpolated image frame may be temporally located between the preceding image frame and the current image frame. The pixel value for the pixel location within the interpolated image frame may be determined based on the pixel value for the pixel label_a.

The pixel level motion vectors 122b-122i may be computed by a method substantially similar to that disclosed above. For each computed pixel level motion vector, a corresponding pixel within the interpolated image frame may be generated.

In another exemplary embodiment of the invention the weighted median block 228 may utilize the vector median computation method. In this case, each of the motion vector tuples, (Δv_xₖ, Δv_yₖ), may be represented by a vector [symbol] ₖ. A vector median (VM), [symbol] _{VM}, may be computed based on the plurality of vectors as shown in the following equation:

VM( [symbol] ₁₁₂ₐ, [symbol] _{112b},K, [symbol] ₁₁₂ᵢ)= [symbol] _{VM} [4]

where for a given pixel location j:

$${\sum }_{k} {w}_{j , k} \cdot {‖ {{X}^{V}}_{VM} - {{X}^{V}}_{k} ‖}_{L} \leq {\sum }_{k} {w}_{j , k} \cdot {‖ {{X}^{V}}_{l} - {{X}^{V}}_{k} ‖}_{L} \qquad [ 5 ]$$

where k and l may each be selected from the set of motion vectors (112a, 112b, 112c, 112d, 112e, 112f, 112g, 112h, 112i) and L represents an order for a distance measurement. For example L=1 may represent an absolute value computation and L=2 may represent a Euclidean distance computation.

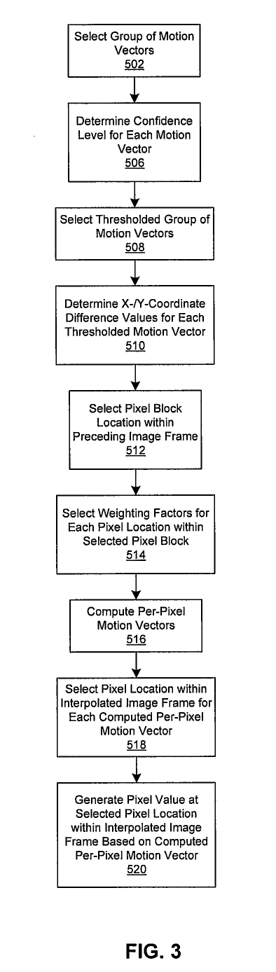

FIG. 3 is a flowchart illustrating exemplary steps for pixel adaptive weighted median filtering for motion vector decomposition, in accordance with an embodiment of the invention. Referring to FIG. 3, in step 502, a group of computed pixel block level motion vectors may be selected, 112a, 112b, 112c, 112d, 112e, 112f, 112g, 112h and 112i. The selected group of pixel block level motion vectors may be utilized to enable computation of pixel level motion vectors, 122a, 122b, 122c, 122d, 122e, 122f, 122g, 122h and 122i. In step 506, a confidence level may be determined for each of the pixel block level motion vectors. In step 508, each confidence attribute may be compared to a threshold value. A thresholded group of motion vectors may be determined based on the comparisons. In step 510 x-y coordinate difference values may be computed for each of the thresholded motion vectors. The x-y coordinate difference values may be computed based on locations in preceding and current image frames. In step 512, a pixel block location for a preceding image processing block 104e, may be selected within the preceding image frame 102a. In step 514, weighting factors, w_{m,n}, may be selected for each pixel location (A-I) within the selected pixel block 104e.

In step 516, a group of pixel level motion vectors may be computed for the selected pixel block. Each pixel level motion vector, 122a, 122b, 122c, 122d, 122e, 122f, 122g, 122h and 122i corresponds to one of the pixel locations A, B, C, D, E, F, G, H and I within the image processing block 104e. In various exemplary embodiments of the invention, a scalar median method or vector median method may be utilized, in addition to other foreseeable methods for computing pixel level motion vectors based on a group of pixel block level motion vectors. In step 518, for each of the computed pixel level motion vectors 122a, 122b, 122c, 122d, 122e, 122f, 122g and 122i, a pixel location may be selected within an interpolated image frame. In step 520, a pixel value may be determined for the pixel location within the interpolated image frame based on the computer pixel level motion and corresponding pixel value within the preceding image frame.

Another embodiment of the invention may provide a computer readable medium having stored thereon, a computer program having at least one code section executable by a computer, thereby causing the computer to perform steps as described herein for pixel adaptive weighted median filtering for block motion vector decomposition.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for image processing, the system comprising:
one or more circuits that enable decomposition of a plurality of pixel block level motion vectors into a plurality of pixel level motion vectors in an image processing system; and
said one or more circuits enable generation of a plurality of pixel values within an interpolated image frame based on said plurality of pixel level motion vectors.

2. The system according to claim 1, wherein said one or more circuits enable generation of a plurality of thresholded motion vectors by comparing a confidence attribute associated with each of said plurality of pixel block level motion vectors to a threshold value.

3. The system according to claim 2, wherein said one or more circuits enable generation of a plurality of weighting factors corresponding to said plurality of thresholded motion vectors.

4. The system according to claim 3, wherein said one or more circuits enable generation of one or more sets of motion vector coordinate values based on said plurality of weighting factors.

5. The system according to claim 4, wherein said one or more circuits enable computation of one or more median values based on said generated one or more sets of motion vector coordinate values.

6. The system according to claim 5, wherein said one or more circuits enable said computation of said one or more median values by sorting said generated one or more sets of motion vector coordinate values in one of: ascending order and descending order.

7. The system according to claim 6, wherein said one or more circuits enable computation of one or both of: an x-component value and a y-component value; based on said computed one or more median values.

8. The system according to claim 7, wherein said one or more circuits enable computation of at least one of said plurality of pixel level motion vectors based on said x-component value and/or said y-component value.

9. The system according to claim 3, wherein said one or more circuits enable generation of a vector representation for each of said plurality of thresholded motion vectors.

10. The system according to claim 9, wherein said one or more circuits enable computation of a vector distance sum based on a computed distance between a selected one of said plurality of vector representations and each of said plurality of representations based on said plurality of weighting factors.

11. The system according to claim 10, wherein said one or more circuits enable computation of a distinct said vector distance sum for each distinct said selected one of said plurality of said plurality of vector representations.

12. The system according to claim 11, wherein said one or more circuits enable computation of a median distance sum that is less than or equal to each of said plurality of distinct vector distance sums.

13. The system according to claim 12, wherein said one or more circuits enable computation of at least one of said plurality of pixel level motion vectors based on said computed median distance sum.

14. A method for image processing, the method comprising:
decomposing a plurality of pixel block level motion vectors into a plurality of pixel level motion vectors in an image processing system; and
generating a plurality of pixel values within an interpolated image frame based on said plurality of pixel level motion vectors.

15. The method according to claim 14, comprising generating a plurality of thresholded motion vectors by comparing a confidence attribute associated with each of said plurality of pixel block level motion vectors to a threshold value.

16. The method according to claim 15, comprising generating a plurality of weighting factors corresponding to said plurality of thresholded motion vectors.

17. The method according to claim 16, comprising generating one or more sets of motion vector coordinate values based on said plurality of weighting factors.

18. The method according to claim 17, comprising computing one or more median values based on said generated one or more sets of motion vector coordinate values.

19. The method according to claim 18, comprising computing said one or more median values by sorting said generated one or more sets of motion vector coordinate values in one of: ascending order and descending order.

20. The method according to claim 19, comprising computing one or both of: an x-component value and a y-component value; based on said computed one or more median values.

21. The method according to claim 20, comprising computing at least one of said plurality of pixel level motion vectors based on said x-component value and/or said y-component value.

22. The method according to claim 16, comprising generating a vector representation for each of said plurality of thresholded motion vectors.

23. The method according to claim 22, comprising computing a vector distance sum based on a computed distance between a selected one of said plurality of vector representations and each of said plurality of representations based on said plurality of weighting factors.

24. The method according to claim 23, comprising computing a distinct said vector distance sum for each distinct said selected one of said plurality of said plurality of vector representations.

25. The method according to claim 24, comprising computing a median distance sum that is less than or equal to each of said plurality of distinct vector distance sums.
